(19) United States
(12) Patent Application Publication
(10) Pub. No.: US 2025/0347375 A1
(43) Pub. Date: Nov. 13, 2025

(54) COMMUNICATING STRUCTURE

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/192,382

(22) Filed: Apr. 29, 2025

(30) Foreign Application Priority Data
May 9, 2024 (TW) 113117177
Nov. 14, 2024 (TW) 113143907

(51) Int. Cl. F16L 37/14; F16L 37/38

(52) U.S. Cl. CPC F16L 37/14; F16L 37/38

(57) ABSTRACT

A communicating structure and a communicating method therefor are introduced. The communicating structure includes a body portion and a movable portion. The body portion is provided with a joining portion. The movable portion is movably fitted with the body portion. The movable portion is provided with a snap-fit portion fitted with the joining portion. The snap-fit portion is snap-fitted to an object or another body portion. In this way, the body portion may be snap-fitted to or unfastened from the object or the another body portion through the movable portion, to complete quick engagement and disengagement of at least two objects, thereby achieving repeated and quick engagement and disengagement.

### CROSS-REFERENCE TO RELATED APPLICATION

This non-provisional application claims priority under 35 U.S.C. § 119(a) on Patent Application No(s). 113117177 filed in Taiwan, R.O.C. on May 9, 2024, and Patent Application No(s). 113143907 filed in Taiwan, R.O.C. on Nov. 14, 2024, the entire contents of which are hereby incorporated by reference.

### BACKGROUND OF THE INVENTION

### 1. Field of the Invention

The present disclosure provides a communicating structure, and in particular, to a communicating structure that may serve to repeatedly and quickly engage and disengage at least two objects and a communicating method therefor.

### 2. Description of the Related Art

Generally, during engagement of at least one object, the object is usually locked by screws to realize the engagement of the object.

In terms of the conventional fixing manner described above, although at least one object can be fixed and engaged in a manner that is not prone to disengagement, in addition to a case of being not prone to assembly, the fixing and engaging manner of the screws may cause at least one object to be not easily disassembled.

### BRIEF SUMMARY OF THE INVENTION

In view of the foregoing conventional technology, the inventor has developed a communicating structure and a communicating method therefor, to achieve the effects of repeated and quick engagement and disengagement.

To achieve the above purpose and other purposes, the present disclosure provides a communicating structure, including a body portion and at least one movable portion. The movable portion is movably fitted with the body portion, or the movable portion is configured to be snap-fitted to an object or another body portion.

The present disclosure provides another communicating structure, including a body portion and at least one movable portion. The body portion is provided with at least one joining portion. The movable portion is movably fitted with the body portion. The movable portion is provided with at least one snap-fit portion fitted with the joining portion. The snap-fit portion is snap-fitted to an object or another body portion.

The present disclosure provides another communicating method of a communicating structure. The communicating structure includes a body portion and a movable portion. The movable portion is movably fitted with the body portion. The movable portion is docked with a joining portion and a docking portion of the body portion through a snap-fit portion. The movable portion is further fitted with the body portion through an operating portion and an elastic element, or the operating portion is fitted with the movable portion through a joining member, and then fitted with the elastic element and the body portion.

The present disclosure provides another communicating method of a communicating structure. The communicating structure includes a body portion and a movable portion. The movable portion is movably fitted with the body portion. The body portion is docked with another body portion to bring a flow channel between the body portion and the another body portion into communication or allow passage of a fluid, or the fluid is a liquid, a gas, or oil.

The present disclosure provides another communicating method of a communicating structure. The communicating structure includes a body portion and a movable portion. The movable portion is movably fitted with the body portion. The body portion is a fluid connector or quick-release connector for connecting a server, a computer, an integrated circuit (IC), a chip, a conductor, a motherboard, or a data center.

The present disclosure provides another communicating method of a communicating structure. The communicating structure includes a body portion and a movable portion. Another docking portion of the movable portion is docked with a docking portion of the body portion, and another joining portion is fitted with a joining portion of the body portion through a movement space of the movable portion, so that the movable portion is movably fitted with the body portion.

The present disclosure provides another communicating method of a communicating structure. The communicating structure includes a body portion and a movable portion. The movable portion is movably fitted with the body portion. The movable portion is movably fitted with the body portion or another body portion. The body portion or the another body portion has a flow channel, the body portion or the another body portion is formed through injection of a liquid material into a mold and then curing, or the body portion or the another body portion is formed through injection of a liquid material into a mold and then cooling and curing, the body portion or the another body portion is formed through the mold using a combination of a plurality of modules, the mold or the modules block a position of the flow channel to prevent the liquid material from flowing through the flow channel to form the flow channel, the mold has at least one flow path for the liquid material to enter the mold to form the body portion or the another body portion, or the liquid material is a metal material, a non-metal material, or a plastic material.

The present disclosure provides another communicating method of a communicating structure. The communicating structure includes a body portion and a movable portion. The movable portion is movably fitted with the body portion, or the movable portion or the body portion is movably fitted with another body portion. The body portion or the another body portion is stopped by a mold to form a mounting portion during liquid injection, a limiting member is mounted to the mounting portion after formation, so that the limiting member limits elastic movement of an elastic member and a blocking member. A blocking portion is mounted to the limiting member to limit the elastic member and the blocking member, the limiting member is an elastic member configured to be snapped into the mounting portion, or the mounting portion is a hole portion, a groove portion, a concave portion, or a convex portion. The body portion or the another body portion has a mounting portion, a limiting member is mounted to the mounting portion, so that the limiting member limits elastic movement of an elastic member and a blocking member, a blocking portion is mounted to the limiting member to limit the elastic member and the blocking member, the limiting member is an elastic member configured to be snapped into the mounting portion, the mounting portion is a hole portion, a groove portion, a concave portion, or a convex portion, or a structure of the limiting member allows passage of a fluid passing through the body portion or an object or the another body portion.

The present disclosure provides another communicating method of a communicating structure. The communicating structure includes a body portion and a movable portion. The movable portion is movably fitted with the body portion. The body portion is provided with an embedded portion, the embedded portion is configured to be placed in a mold for liquid injection molding of the body portion, and a fluid blocking member is arranged on an arrangement portion of the embedded portion. The embedded portion is made of a metal material, the body portion is made of a plastic material, or the fluid blocking member is an O-ring, a rubber substance, a non-metallic substance, or a substance configured to block a fluid, or two fluid blocking members are arranged. The embedded portion is configured to be placed in a mold for liquid injection molding of the body portion and then a fluid blocking member is arranged on an arrangement portion of the embedded portion, or the communicating structure has another body portion, the another body portion is docked with the body portion, and the fluid blocking member is configured to prevent a liquid flowing through the body portion and the another body portion from flowing out or overflowing. Alternatively, the body portion is provided with an embedded portion, a fluid blocking member is arranged on an arrangement portion of the embedded portion, the embedded portion is made of a metal material or a plastic material, the body portion is made of a plastic material or a metal material, or the fluid blocking member is an O-ring, a rubber substance, a non-metallic substance, or a substance configured to block a fluid, or two fluid blocking members are arranged, the embedded portion is configured to be placed in a mold for liquid injection molding of the body portion and then a fluid blocking member is arranged on an arrangement portion of the embedded portion, the embedded portion is configured to be placed in a solid body portion for assembly, a fluid blocking member is arranged on an arrangement portion of the embedded portion, or the another body portion is docked with the body portion. The fluid blocking member is configured to prevent the liquid flowing through the body portion and the another body portion from flowing out or overflowing.

In the communicating structure and the communicating method therefor described above, the movable portion is provided with an operating portion, the operating portion and the movable portion are joined through a joining member, or the operating portion and the movable portion are first clamped or snap-fitted and then joined through the joining member.

In the communicating structure and the communicating method therefor described above, an elastic element is arranged between the movable portion and the body portion. The elastic element is configured to provide an elastic force or an elastic force for movement and snap-fitting.

In the communicating structure and the communicating method therefor described above, the body portion is provided with a docking portion, the docking portion is docked with the movable portion, or the docking portion is a cut edge, a cut groove, a groove portion, or a hole portion.

In the communicating structure and the communicating method therefor described above, the body portion is provided with at least one joining portion, the movable portion is provided with at least one snap-fit portion fitted with the joining portion, or the snap-fit portion is a hole portion or a groove portion.

In the communicating structure and the communicating method therefor described above, one or two joining portions are arranged, and the joining portions are respectively docked with one or two snap-fit portions of the movable portion.

In the communicating structure and the communicating method therefor described above, the body portion or the movable portion is made of metal, non-metal, plastic, metal with an electroplated surface, or metal subjected to heat treatment to increase elasticity.

In the communicating structure and the communicating method therefor described above, the snap-fit portion is provided with an inclined surface. The inclined surface is configured to be snap-fitted or move corresponding to an inclined surface of the another body portion or an inclined surface of the another object.

In the communicating structure and the communicating method therefor described above, the snap-fit portion is a column member, a curved surface-equipped member, a sheet member, or an inclined surface-equipped member.

In the communicating structure and the communicating method therefor described above, the joining portion is a hole portion or a groove portion.

In the communicating structure and the communicating method therefor described above, the joining portion or the snap-fit portion is manufactured into a hole portion or a groove portion through computer numerical control (CNC), lathing, or a milling machine.

In the communicating structure and the communicating method therefor described above, the movable portion is provided with an entry portion. The entry portion is configured for the another body portion to enter.

In the communicating structure and the communicating method therefor described above, the body portion is provided with a docking portion. The movable portion is provided with another docking portion. The docking portion and the another docking portion are docked with each other.

In the communicating structure and the communicating method therefor described above, the docking portion or the another docking portion is a convex rib, a hole portion, or a groove portion.

In the communicating structure and the communicating method therefor described above, the movable portion is provided with a movement space, and another joining portion is fitted to the joining portion of the body portion through the movement space, so that the movable portion is fitted to or moves on the body portion.

In the communicating structure and the communicating method therefor described above, the movable portion is a spherical member, a convex member, a concave member, a hook member, a fastening member, a snap member, or an elastic member, or the movable portion is a snap-fit portion, or the movable portion and the snap-fit portion are integrally formed or assembled, or the snap-fit portion is a spherical member, a convex member, a concave member, a hook member, a snap member, or an elastic member, the joining portion is a riveted member, an expanded member, a locked member, a welded member, a hole, a groove, a convex member, a concave member, or an object having a head portion, or the joining portion or the snap-fit portion is formed through injection molding, in-mold injection molding, metal injection molding, or plastic injection molding, or the snap-fit portion is a spherical member, a convex member, a concave member, a hook member, a snap member, or an elastic member, or the body portion or the object or the another body portion is configured to allow a fluid to flow through, or the fluid is water, a water-cooling liquid, oil, a gas, or air.

In the communicating structure and the communicating method therefor described above, the movable portion is provided with an elastic retraction space. The elastic retraction space is configured to allow the another joining portion of the movable portion to retract and then be snap-fitted to the joining portion.

In the communicating structure and the communicating method therefor described above, the elastic retraction space is a groove, a hole, an open groove, or a closed groove.

In the communicating structure and the communicating method therefor described above, the joining portion is provided with a movement space. The movement space is joined with another joining portion of the movable portion to movably join the movable portion.

In the communicating structure and the communicating method therefor described above, the body portion is provided with a resisting portion configured to enable the object to be snap-fitted between the snap-fit portion and the resisting portion.

In the communicating structure and the communicating method therefor described above, the body portion is provided with a flow channel. A floating space is provided between the flow channel and the body portion, which is configured for floating alignment for docking when the body portion is docked with the object.

In the communicating structure and the communicating method therefor described above, a floating space is provided between the body portion and the object, which is configured for floating alignment for docking when the body portion is docked with the object.

In the communicating structure and the communicating method therefor described above, the body portion has a fluid quick-release connector or a flow channel joined thereto, the flow channel is in communication with a heat sink or a heating member to take away a heat source or reduce the heat source, the heat sink or the heating member is arranged in a server, a computer, a data center, or a storage, or the communicating structure is a quick-release connector, or the communicating structure is a fluid quick-release connector.

In the communicating structure and the communicating method therefor described above, the snap-fit portion is provided with an actuating portion, the actuating portion is configured to actuate the snap-fit portion, or the object is snap-fitted to or limited between the snap-fit portion and the actuating portion.

In the communicating structure and the communicating method therefor described above, the body portion is provided with a flow channel therein, an elastic element or a limiting member is arranged between the body portion and the flow channel, the elastic element and the limiting member are configured to elastically limit the flow channel in the body portion, a floating space is provided between the body portion and the limiting member, a floating space is provided between the elastic element and the body portion, or a floating space is provided between the elastic element and the flow channel.

In the communicating structure and the communicating method therefor described above, the body portion or the flow channel is a tube member, a pipeline, a quick connector, a liquid quick-release connector, a water-cooling liquid quick-release connector, a floating tube member, a floating connector, a metal member, a non-metallic member, a fastening member, an elastic member, a floating member, a blocking member, or a fluid channel.

In the communicating structure and the communicating method therefor described above, the joining portion is joined to an object, or the joining portion is provided with a rotation prevention portion, and the rotation prevention portion is configured to prevent rotation or limit a direction of the object.

In the communicating structure and the communicating method therefor described above, two body portions are arranged, the body portions each are provided with a blocking member, or the blocking members push against each other to respectively open a flow channel of each of the body portions, or to allow the fluid to flow in the flow channel in each of the body portions, or the two body portions are quick-release connectors or liquid quick-release connectors.

In the communicating structure and the communicating method therefor described above, the body portion is provided with a docking portion. The docking portion is a rotation prevention structure to prevent rotation of the docking portion and the movable portion.

In the communicating structure and the communicating method therefor described above, the joining portion is a groove portion, a concave portion, a convex portion, a fastening portion, an open space, or an open structure, so that the joining portion is configured to allow arrangement of a movable portion or a snap-fit portion of the movable portion.

In the communicating structure and the communicating method therefor described above, the body portion is provided with an engaging portion, the body portion is provided with the movable portion and a fitting portion of the body portion is joined to the engaging portion to limit the movable portion, or the fitting portion is an externally threaded member, an internally threaded member, a snap member, a threaded member, a fastening member, a C-shaped buckle, a ring member, a riveted member, a welded member, or a flange riveted member.

In the communicating structure and the communicating method therefor described above, the body portion is provided with a docking portion, and the movable portion is provided with another docking portion. The movable portion enters the body portion through the another docking portion, so that the movable portion is snap-fitted to a buckle portion of the body portion through a snap portion. The buckle portion is an open structure, or the snap portion passes over or through a flow channel of the body portion and then is snap-fitted to the buckle portion.

In the communicating structure and the communicating method therefor described above, the body portion or the another body portion has a flow channel, the body portion or the another body portion is formed through injection of a liquid material into a mold and then curing, or the body portion or the another body portion is formed through injection of a liquid material into a mold and then cooling and curing, the body portion or the another body portion is formed through the mold using a combination of a plurality of modules, or the mold or the modules block a position of the flow channel to prevent the liquid material from flowing through the flow channel to form the flow channel, or the mold has at least one flow path for the liquid material to enter the mold to form the body portion or the another body portion, or the liquid material is a metal material, a non-metal material, or a plastic material.

In the communicating structure and the communicating method therefor described above, the body portion or the another body portion is stopped by a mold to form a mounting portion during liquid injection, a limiting member is mounted to the mounting portion after formation, so that the limiting member limits elastic movement of an elastic member and a blocking member, or a blocking portion is mounted to the limiting member to limit the elastic member and the blocking member, or the limiting member is an elastic member configured to be snapped into the mounting portion, or the mounting portion is a hole portion, a groove portion, a concave portion, or a convex portion.

In the communicating structure and the communicating method therefor described above, the body portion or the another body portion has a mounting portion, a limiting member is mounted to the mounting portion, so that the limiting member limits elastic movement of an elastic member and a blocking member, a blocking portion is mounted to the limiting member to limit the elastic member and the blocking member, the limiting member is an elastic member configured to be snapped into the mounting portion, or the mounting portion is a hole portion, a groove portion, a concave portion, or a convex portion, or a structure of the limiting member allows passage of a fluid passing through the body portion or an object or the another body portion.

In the communicating structure and the communicating method therefor described above, the body portion is provided with an embedded portion, the embedded portion is configured to be placed in a mold for liquid injection molding of the body portion, or a fluid blocking member is arranged on an arrangement portion of the embedded portion, or the embedded portion is made of a metal material, or the body portion is made of a plastic material, or the fluid blocking member is an O-ring, a rubber substance, a non-metallic substance, or a substance configured to block a fluid, or two fluid blocking members are arranged, or the embedded portion is configured to be placed in a mold for liquid injection molding of the body portion and then a fluid blocking member is arranged on an arrangement portion of the embedded portion, or the another body portion is docked with the body portion, and the fluid blocking member is configured to prevent a liquid flowing through the body portion and the another body portion from flowing out or overflowing.

In the communicating structure and the communicating method therefor described above, the body portion is provided with an embedded portion, or a fluid blocking member is arranged on an arrangement portion of the embedded portion, or the embedded portion is made of a metal material or a plastic material, or the body portion is made of a plastic material or a metal material, or the fluid blocking member is an O-ring, a rubber substance, a non-metallic substance, or a substance configured to block a fluid, or two fluid blocking members are arranged, or the embedded portion is configured to be placed in a mold for liquid injection molding of the body portion and then a fluid blocking member is arranged on an arrangement portion of the embedded portion, or the embedded portion is configured to be placed in a solid body portion for assembly, or a fluid blocking member is arranged on an arrangement portion of the embedded portion, or the another body portion is docked with the body portion, and the fluid blocking member is configured to prevent the liquid flowing through the body portion and the another body portion from flowing out or overflowing.

In the communicating structure and the communicating method therefor described above, the blocking member is a moving part.

In this way, according to the communicating structure and the communicating method therefor, the body portion may be snap-fitted to or unfastened from the object or the another body portion through the movable portion, to complete quick engagement and disengagement of at least two objects, thereby achieving the purpose of repeated and quick engagement and disengagement.

### BRIEF DESCRIPTION OF THE DRAWINGS

FIG. 1 is a schematic exploded view according to a first embodiment of the present disclosure.

FIG. 2 is a schematic cross-sectional view according to a first embodiment of the present disclosure.

FIG. 3 is a schematic diagram of a first embodiment of a movable portion according to the present disclosure.

FIG. 4 is a schematic diagram of a second embodiment of a movable portion according to the present disclosure.

FIG. 5 is a schematic diagram I of a usage state according to a first embodiment of the present disclosure.

FIG. 6 is a schematic diagram II of a usage state according to a first embodiment of the present disclosure.

FIG. 7 is a schematic cross-sectional view according to a second embodiment of the present disclosure.

FIG. 8 is a schematic exploded view according to a third embodiment of the present disclosure.

FIG. 9 is a schematic cross-sectional view I according to a third embodiment of the present disclosure.

FIG. 10 is a schematic cross-sectional view II according to a third embodiment of the present disclosure.

FIG. 11 is a schematic front view according to a third embodiment of the present disclosure.

FIG. 12 is a schematic diagram of a usage state according to a third embodiment of the present disclosure.

FIG. 13 is a schematic diagram of another joining portion according to the present disclosure in different forms.

FIG. 14 is a schematic diagram of a body portion according to a third embodiment of the present disclosure.

FIG. 15 is a schematic exploded view according to a fourth embodiment of the present disclosure.

FIG. 16 is a schematic front view according to a fourth embodiment of the present disclosure.

FIG. 17 is a schematic diagram of a usage state according to a fourth embodiment of the present disclosure.

FIG. 18 is a schematic front view according to a fifth embodiment of the present disclosure.

FIG. 19 is a schematic diagram of a body portion according to a fifth embodiment of the present disclosure.

FIG. 20 is a schematic diagram I of a movable portion according to a fifth embodiment of the present disclosure.

FIG. 21 is a schematic diagram II of a movable portion according to a fifth embodiment of the present disclosure.

FIG. 22 is a schematic cross-sectional view according to a fifth embodiment of the present disclosure.

FIG. 23 is a schematic top view according to a sixth embodiment of the present disclosure.

FIG. 24 is a schematic cross-sectional view according to a sixth embodiment of the present disclosure.

FIG. 25 is a schematic diagram of a body portion according to a sixth embodiment of the present disclosure.

FIG. 26 is a schematic diagram of a usage state according to a sixth embodiment of the present disclosure.

FIG. 27 is a schematic diagram of a usage state according to a seventh embodiment of the present disclosure.

FIG. 28 is a schematic diagram of a usage state according to an eighth embodiment of the present disclosure.

FIG. 29 is a schematic diagram of a usage state according to a ninth embodiment of the present disclosure.

FIG. 30 is a schematic diagram I of a usage state according to a tenth embodiment of the present disclosure.

FIG. 31 is a schematic diagram II of a usage state according to a tenth embodiment of the present disclosure.

FIG. 32 is a schematic diagram of a usage state according to an eleventh embodiment of the present disclosure.

FIG. 33 is a schematic diagram I of a usage state according to a thirteenth embodiment of the present disclosure.

FIG. 34 is a schematic diagram II of a usage state according to a thirteenth embodiment of the present disclosure.

FIG. 35 is a schematic diagram I of a usage state according to a fourteenth embodiment of the present disclosure.

FIG. 36 is a schematic diagram of a fitting portion according to the present disclosure in different forms.

FIG. 37 is a schematic diagram I of a usage state according to a fifteenth embodiment of the present disclosure.

FIG. 38 is a schematic diagram II of a usage state according to a fifteenth embodiment of the present disclosure.

FIG. 39 is a schematic diagram showing an appearance of a body portion according to a sixteenth embodiment of the present disclosure.

FIG. 40 is a schematic exploded view of a body portion according to a sixteenth embodiment of the present disclosure.

FIG. 41 is a schematic cross-sectional view I of a body portion according to a sixteenth embodiment of the present disclosure.

FIG. 42 is a schematic diagram showing an appearance of another body portion according to a sixteenth embodiment of the present disclosure.

FIG. 43 is a schematic cross-sectional view I of another body portion according to a sixteenth embodiment of the present disclosure.

FIG. 44 is a schematic cross-sectional view II of another body portion according to a sixteenth embodiment of the present disclosure.

FIG. 45 is a schematic cross-sectional view I of a usage state according to a sixteenth embodiment of the present disclosure.

FIG. 46 is a schematic cross-sectional view II of a usage state according to a sixteenth embodiment of the present disclosure.

FIG. 47 is a schematic diagram I of a formation manner of a body portion according to the present disclosure.

FIG. 48 is a schematic diagram II of a formation manner of a body portion according to the present disclosure.

FIG. 49 is a schematic diagram I of a formation manner of another body portion according to the present disclosure.

FIG. 50 is a schematic diagram II of a formation manner of another body portion according to the present disclosure.

### DETAILED DESCRIPTION OF THE INVENTION

In order to fully understand the purpose, features, and effects of the present disclosure, the present disclosure is described in detail through the following specific embodiments and the accompanying drawings. The description is as follows.

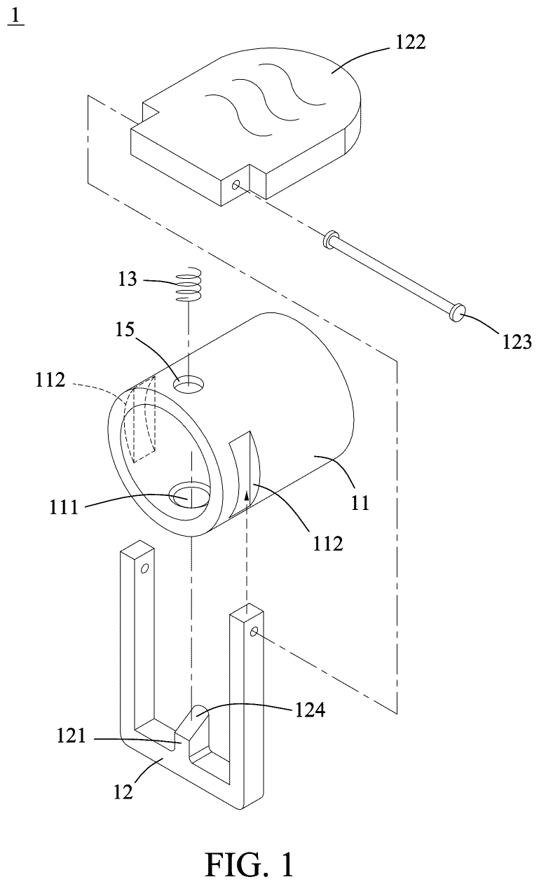

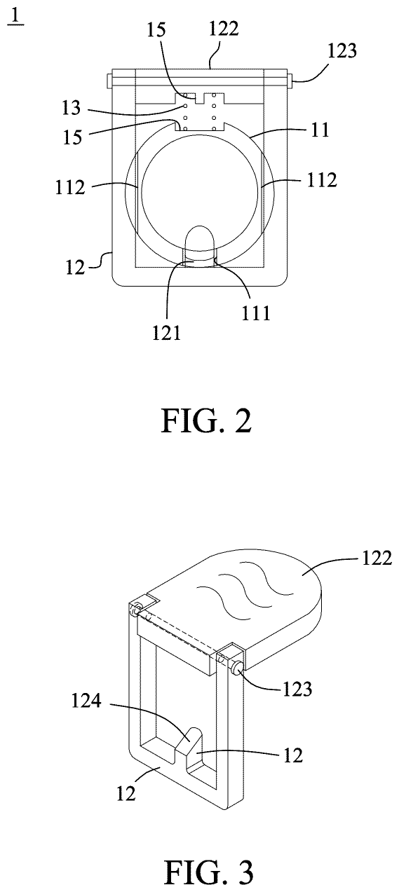

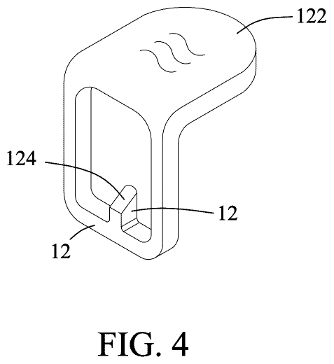

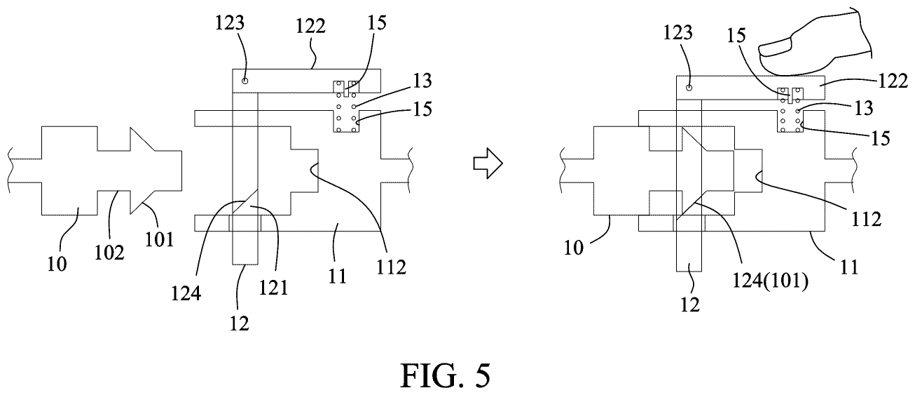

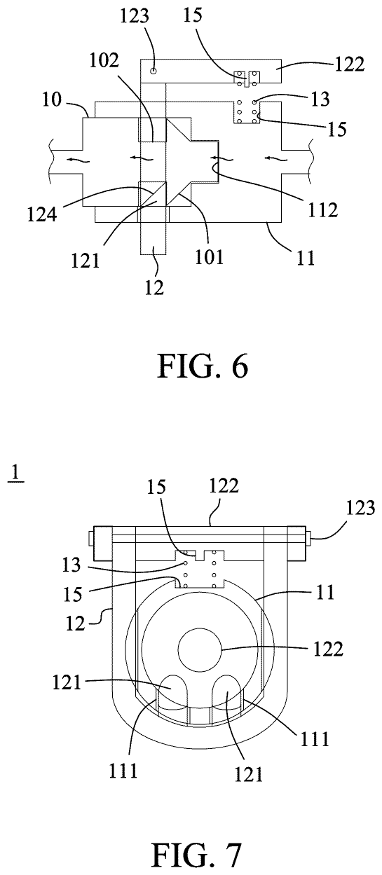

Referring to FIG. 1 to FIG. 6, as shown in the figures, the present disclosure provides a communicating structure and a communicating method therefor. The communicating structure 1 includes a body portion 11 and at least one movable portion 12.

The movable portion 12 and the body portion 11 are movably fitted, so that the body portion 11 is snap-fitted to or unfastened from another body portion 10 (or an object) as required through the movable portion 12, to complete quick engagement and disengagement of at least two objects, thereby achieving the purpose of repeated and quick engagement and disengagement.

In an embodiment of the present disclosure, the body portion 11 is provided with at least one joining portion 111, the movable portion 12 is movably fitted with the body portion 11, and the movable portion 12 is provided with at least one snap-fit portion 121 fitted with the joining portion 111, so that the body portion 11 can be joined to the another body portion 10 (or the object), and the snap-fit portion 121 is snap-fitted to (or unfastened from) a receiving portion 102 of the another body portion 10, to complete quick engagement and disengagement of at least two objects, thereby achieving the purpose of repeated and quick engagement and disengagement.

In addition to the foregoing embodiment, in an embodiment of the present disclosure, a difference from the foregoing embodiment is that the movable portion 12 is provided with an operating portion 122. The operating portion 122 is joined to the movable portion 12 through a joining member 123 (for example, a bolt), so as to apply a force to the operating portion 122 to drive the snap-fit portion 121 of the movable portion 12 to be snap-fitted to (or unfastened from) the another body portion 10.

In addition to the foregoing embodiment, in an embodiment of the present disclosure, a difference from the foregoing embodiment is that an elastic element 13 is arranged between the movable portion 12 and the body portion 11. The elastic element 13 provides an elastic force required by the movable portion 12 or an elastic force during movement and snap-fitting, which is between the body portion 11 and the operating portion 122 in this embodiment of the present disclosure. In this way, through compression and resetting of the elastic element 13, the operating portion 122 drives the snap-fit portion 121 to have the effect of automatic reset during snap-fitting (or unfastening).

In addition to the foregoing embodiment, in an embodiment of the present disclosure, a difference from the foregoing embodiment is that the body portion 11 or the movable portion 12 may be provided with an alignment portion 15 simultaneously or separately, and the elastic element 13 is arranged on the alignment portion 15. In this way, the stability of the elastic element 13 during operation can be maintained through the alignment portion 15.

In addition to the foregoing embodiment, in an embodiment of the present disclosure, a difference from the foregoing embodiment is that the snap-fit portion 121 is provided with an inclined surface 124. The inclined surface 124 is configured to be snap-fitted or move corresponding to an inclined surface 101 of the another body portion 10 (or an inclined surface of another object). In this way, the movable portion 12 and the another body portion 10 may be easily assembled through the inclined surface 124 of the snap-fit portion 121 and the inclined surface 101 of the another body portion 10.

In addition to the foregoing embodiments, in an embodiment of the present disclosure, a difference from the foregoing embodiments is that when in use, after the body portion 11 and the another body portion 10 are snap-fitted, the body portion 11 and the another body portion 10 may be used for guiding a fluid. In this way, the present disclosure can better meet requirements of practical production and use.

In addition to the foregoing embodiments, in an embodiment of the present disclosure, a difference from the foregoing embodiments is that the movable portion 12 may be a spherical member, a convex member, a concave member, a hook member, a fastening member, a snap member, or an elastic member, or the movable portion 12 is a snap-fit portion, or the movable portion 12 and the snap-fit portion 121 are integrally formed or assembled, and the snap-fit portion 121 may be a spherical member, a convex member, a concave member, a hook member, a snap member, or an elastic member. In this way, the present disclosure can better meet the requirements of practical production and use.

In addition to the foregoing embodiments, in an embodiment of the present disclosure, a difference from the foregoing embodiments is that the joining portion 111 and the snap-fit portion 121 may be manufactured into a hole portion or a groove portion, a column member, a curved surface-equipped member, a sheet member, or an inclined surface-equipped member through computer numerical control (CNC), lathing, or a milling machine as required. In this way, the joining portion 111 and the snap-fit portion 121 can better meet the requirements of practical production and use.

In addition to the foregoing embodiments, in an embodiment of the present disclosure, a difference from the foregoing embodiments is that the body portion 11 and the movable portion 12 may be made of metal, non-metal, plastic, metal with an electroplated surface, or metal subjected to heat treatment to increase elasticity. In this way, the body portion 11 and the movable portion 12 can better meet the requirements of practical production and use.

In addition to the foregoing embodiments, in an embodiment of the present disclosure, a difference from the foregoing embodiments is that in the communicating method provided in the present disclosure, the movable portion 12 is movably fitted with the body portion 11, so that the movable portion 12 is docked with the joining portion 111 of the body portion 11 through the snap-fit portion 121, and the operating portion 122 is fitted with the movable portion 12 through the joining member 123, and then fitted with the elastic element 13 and the body portion 11. In this way, the communicating structure 1 is easily assembled.

Referring to FIG. 7, as shown in the figure, in addition to the foregoing embodiments, in an embodiment of the present disclosure, a difference from the foregoing embodiments is that a quantity of joining portions 111 and a quantity of snap-fit portions 121 may be respectively two (or one), so that the joining portions 111 of the body portion 11 are respectively docked with the snap-fit portions 121 of the movable portion 12. In this way, the body portion 11 and the movable portion 12 can have better stability to meet requirements of practical operation.

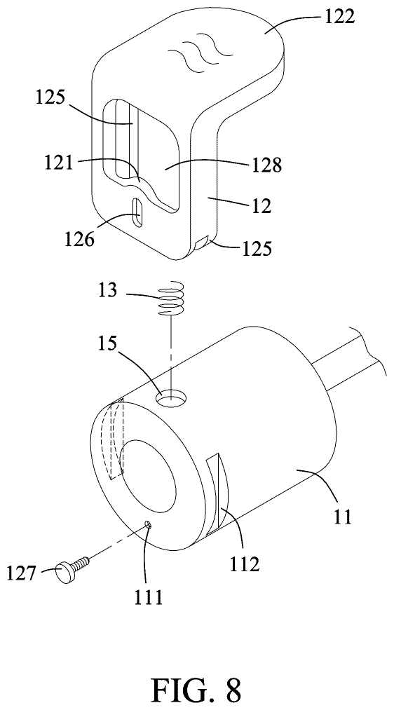

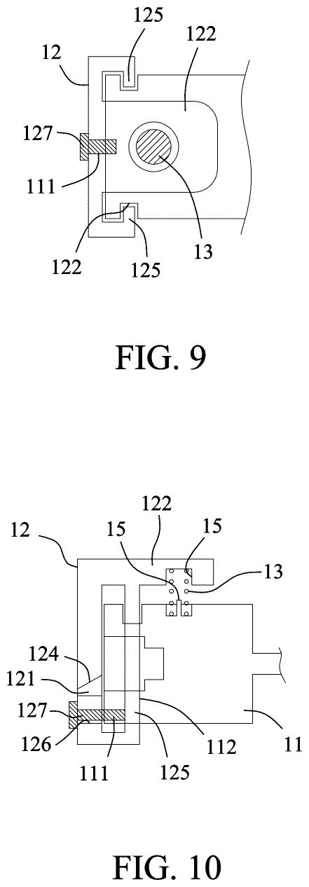

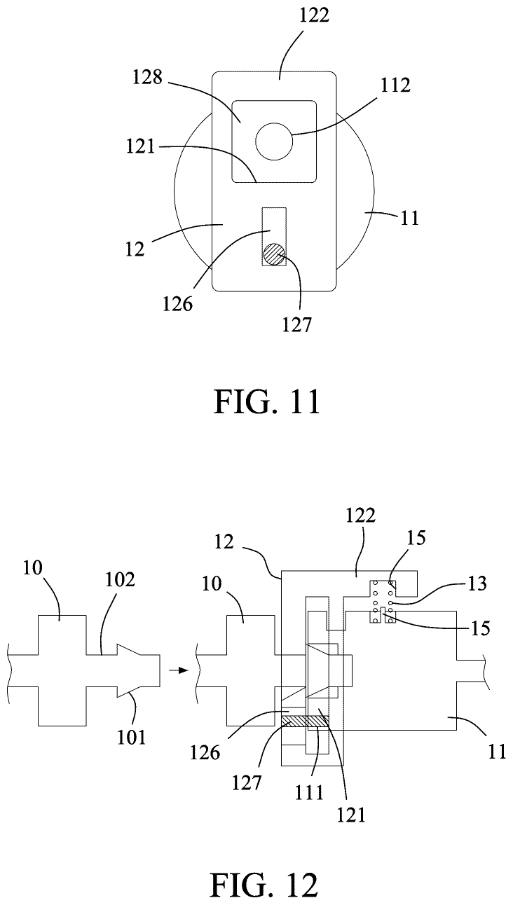

Referring to FIG. 8 to FIG. 14, as shown in the figures, in addition to the foregoing embodiments, in an embodiment of the present disclosure, a difference from the foregoing embodiments is that the body portion 11 is provided with a docking portion 112, and the docking portion 112 is docked with the movable portion 12. The movable portion 12 is provided with another docking portion 125, and the docking portion 112 and the another docking portion 125 are docked with each other. In this way, the body portion 11 may also be snap-fitted to or unfastened from another body portion 10 (or an object) as required through the movable portion 12, to complete quick engagement and disengagement of at least two objects, thereby achieving the purpose of repeated and quick engagement and disengagement.

In addition to the foregoing embodiments, in an embodiment of the present disclosure, a difference from the foregoing embodiments is that the movable portion 12 is provided with a movement space 126, and another joining portion 127 of the movable portion is fitted to the joining portion 111 of the body portion 11 through the movement space 126, so that the movable portion 12 is fitted to or moves on the body portion 11.

In addition to the foregoing embodiments, in an embodiment of the present disclosure, a difference from the foregoing embodiments is that the movable portion 12 is provided with an entry portion 128. The entry portion 128 is configured for the another body portion 10 to enter. In this way, the body portion 11 is snap-fitted to or unfastened from the another body portion 10 (or the object) as required through the movable portion 12, to complete quick engagement and disengagement of at least two objects, thereby achieving the purpose of repeated and quick engagement and disengagement.

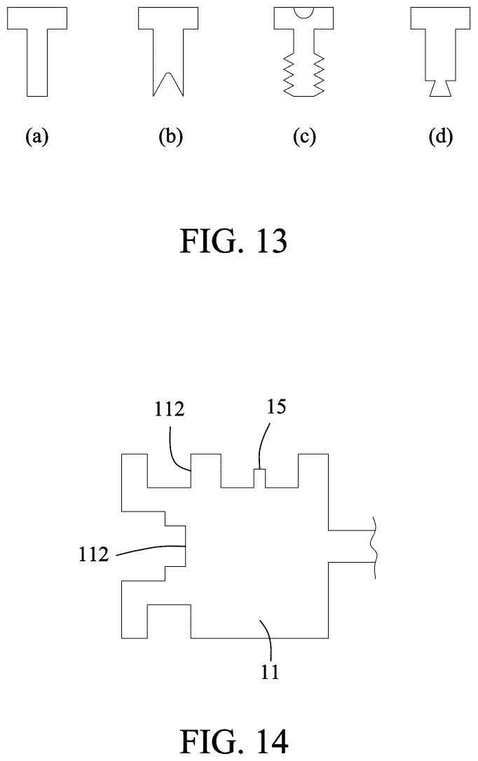

In addition to the foregoing embodiments, in an embodiment of the present disclosure, a difference from the foregoing embodiments is that the another joining portion 127 is a riveted member (as shown in part a of FIG. 13), an expanded member (as shown in part b of FIG. 13), a locked member (as shown in part c of FIG. 13), a welded member, a welded member, a hole member, a groove member, a convex member, a concave member, or an object with a head portion, or the joining portion 111 or the snap-fit portion 121 is formed through injection molding, in-mold injection molding, metal injection molding, or plastic injection molding, or the snap-fit portion 121 may be a spherical member, a convex member, a concave member, a hook member, a snap member, or an elastic member. In this way, the another joining portion 127 can better meet the requirements of practical production and use.

In addition to the foregoing embodiments, in an embodiment of the present disclosure, a difference from the foregoing embodiments is that the docking portion 112 and the another docking portion 125 may be convex ribs, cut edges, cut grooves, hole portions, or groove portions (as shown in FIG. 14). In this way, the docking portion 112 and the another docking portion 125 can better meet the requirements of practical production and use.

In addition to the foregoing embodiments, in an embodiment of the present disclosure, a difference from the foregoing embodiments is that in the communicating method provided in the present disclosure, the movable portion 12 is movably fitted with the body portion 11, so that the movable portion 12 is docked with the joining portion 111 of the body portion 11 and the docking portion 112 through the snap-fit portion 121, and then the movable portion 12 is fitted with the body portion 11 through the operating portion 122 and the elastic element 13. In this way, the communicating structure 1 is easily assembled.

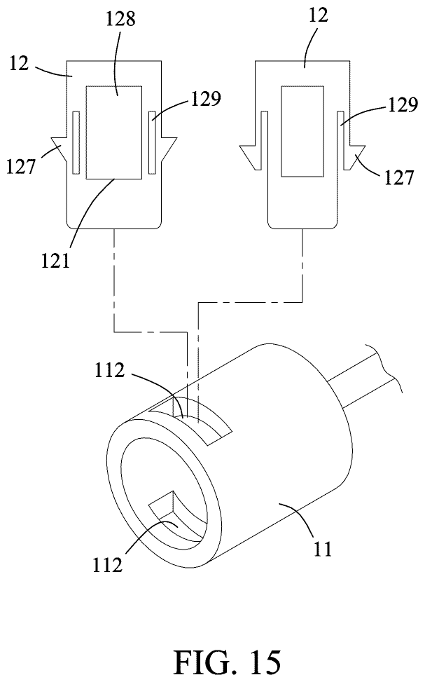

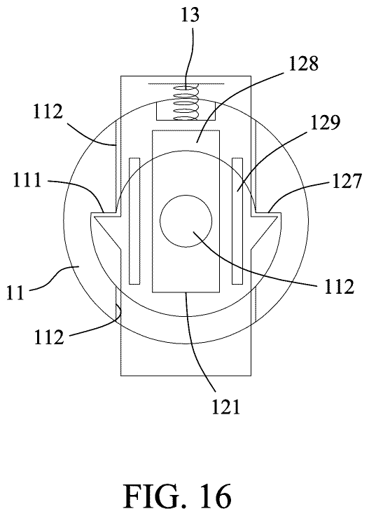

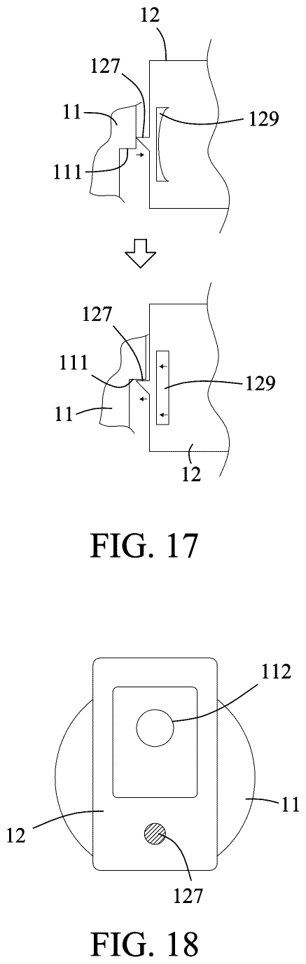

Referring to FIG. 15 to FIG. 17, as shown in the figures, in addition to the foregoing embodiments, in an embodiment of the present disclosure, a difference from the foregoing embodiments is that the movable portion 12 is provided with an elastic retraction space 129, and the elastic retraction space 129 is configured to allow the another joining portion 127 of the movable portion 12 to retract and then be snap-fitted to the joining portion 111 of the body portion 11. In this way, the body portion 11 is snap-fitted to or unfastened from the another body portion 10 (or the object) as required through the movable portion 12, to complete quick engagement and disengagement of at least two objects, thereby achieving the purpose of repeated and quick engagement and disengagement.

In addition to the foregoing embodiments, in an embodiment of the present disclosure, a difference from the foregoing embodiments is that the elastic retraction space 129 may be a groove, a hole, an open groove, or a closed groove. In this way, the elastic retraction space 129 can better meet the requirements of practical production and use.

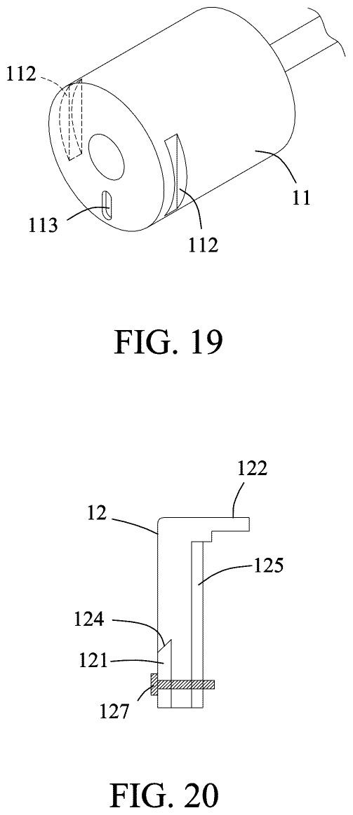

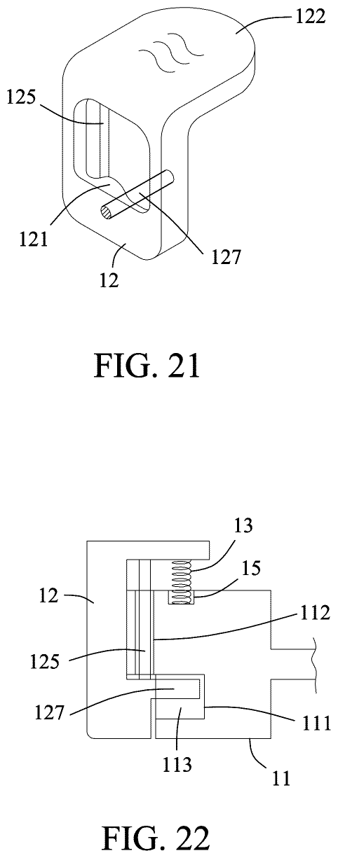

Referring to FIG. 18 to FIG. 22, as shown in the figures, in addition to the foregoing embodiments, in an embodiment of the present disclosure, a difference from the foregoing embodiments is that the joining portion 111 of the body portion 11 is provided with a movement space 113, and the movement space 113 of the joining portion 111 is joined with another joining portion 127 of the movable portion 12, so that the body portion 11 can be movably joined to the movable portion 12. In this way, the body portion 11 may also be snap-fitted to or unfastened from another body portion 10 (or an object) as required through the movable portion 12, to complete quick engagement and disengagement of at least two objects, thereby achieving the purpose of repeated and quick engagement and disengagement.

In addition to the foregoing embodiments, in an embodiment of the present disclosure, a difference from the foregoing embodiments is that in the communicating method provided in the present disclosure, through the communicating structure 1, the another docking portion 125 of the movable portion 12 may be docked with the docking portion 112 of the body portion 11, and the another joining portion 127 is fitted with the joining portion 111 of the body portion 11 through the movement space 113 of the movable portion 12, so that the movable portion 12 and the body portion 11 can be movably fitted. In this way, the communicating structure 1 is easily assembled.

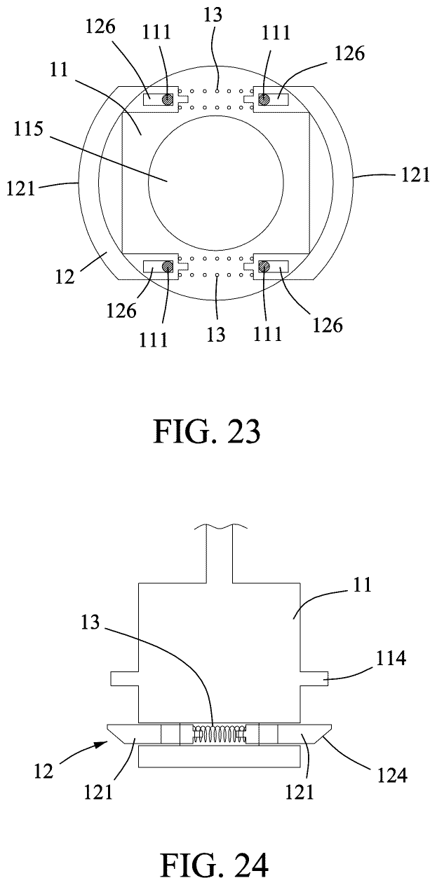

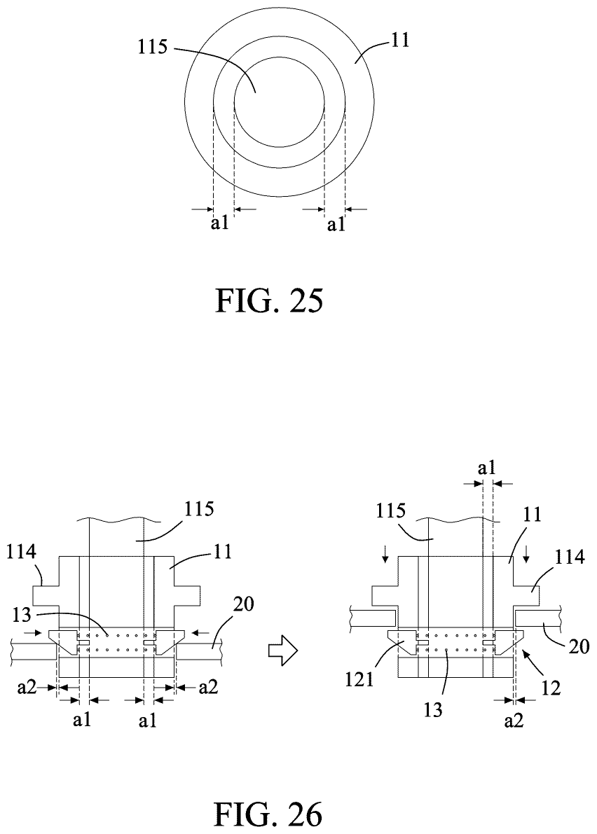

Referring to FIG. 23 to FIG. 26, as shown in the figures, in addition to the foregoing embodiments, in an embodiment of the present disclosure, a difference from the foregoing embodiments is that the body portion 11 is provided with a resisting portion 114 configured to enable the object 20 to be snap-fitted between the snap-fit portion 121 and the resisting portion 114. In this way, the body portion 11 may also be snap-fitted to or unfastened from the object 20 (or the another body portion) as required through the movable portion 12, to complete quick engagement and disengagement of at least two objects, thereby achieving the purpose of repeated and quick engagement and disengagement.

In addition to the foregoing embodiments, in an embodiment of the present disclosure, a difference from the foregoing embodiments is that the body portion 11 is provided with a flow channel 115, a floating space al is provided between the flow channel 115 and the body portion 11, and a floating space a2 is provided between the body portion 11 and the object 20. In this way, the flow channel 115, the body portion 11, and the object 20 have a floating (or fine-tuning) function during operation through the floating spaces a1 and a2 to meet the requirements of practical application and assembly.

In addition to the foregoing embodiments, in an embodiment of the present disclosure, a difference from the foregoing embodiments is that in the communicating method provided in the present disclosure, the body portion 11 is docked with the another body portion 10 to bring the body portion 11 into communication with the flow channel 115 of the another body portion 10. A fluid is supplied to the flow channel 115, or the fluid may be a liquid, a gas, or oil. In this way, the present disclosure can better meet requirements of practical application.

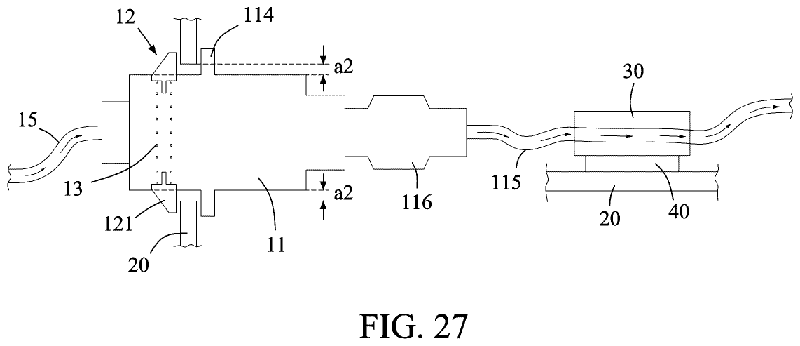

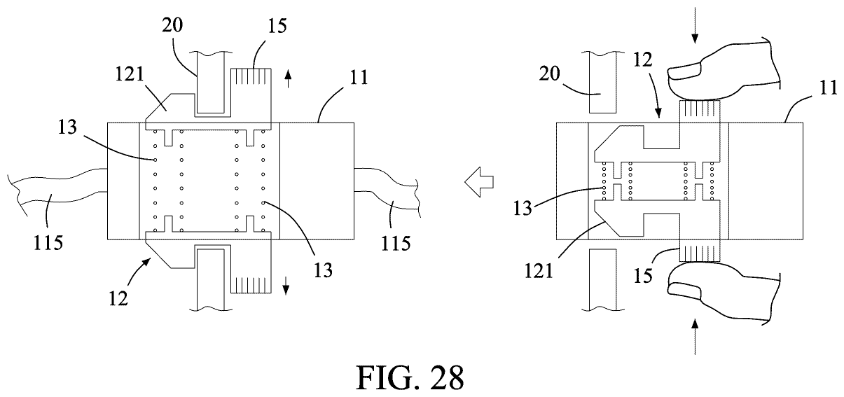

Referring to FIG. 27 and FIG. 28, as shown in the figures, in addition to the foregoing embodiments, in an embodiment of the present disclosure, a difference from the foregoing embodiments is that the body portion 11 has a fluid quick-release connector 116 joined thereto, and the fluid quick-release connector 116 is provided with a flow channel 115. A fluid (for example, liquid, gas, or oil) is supplied to the flow channel 115, and the flow channel 115 is in communication with a heat sink 30 and a heating member 40, so that the flow channel 115 cooperates with the fluid to take away a heat source of the heat sink 30 (or the heating member 40) or reduce the heat source. In this way, the communicating structure 1 may be configured to connect the heat sink 30.

In addition to the foregoing embodiment, in an embodiment of the present disclosure, a difference from the foregoing embodiment is that the snap-fit portion 121 is provided with an actuating portion 14, and the actuating portion 14 is configured to actuate the snap-fit portion 121, so that the object 20 is snap-fitted to (or limited) between the snap-fit portion 121 and the actuating portion 14. In this way, the object 20 can be firmly engaged with the body portion 11.

In addition to the foregoing embodiments, in an embodiment of the present disclosure, a difference from the foregoing embodiments is that the body portion 11 may be a fluid connector or a quick-release connector connected to a server, a computer, an integrated circuit (IC), a chip, a conductor, a motherboard, a data center, or a chip, and the heat sink 30 or the heating member 40 may be arranged on the server, the computer, the IC, the chip, the conductor, the motherboard, the data center, or a storage, or the communicating structure 1 may be a quick-release connector, or the communicating structure 1 may be a fluid quick-release connector. In this way, the present disclosure can better meet the requirements of practical application.

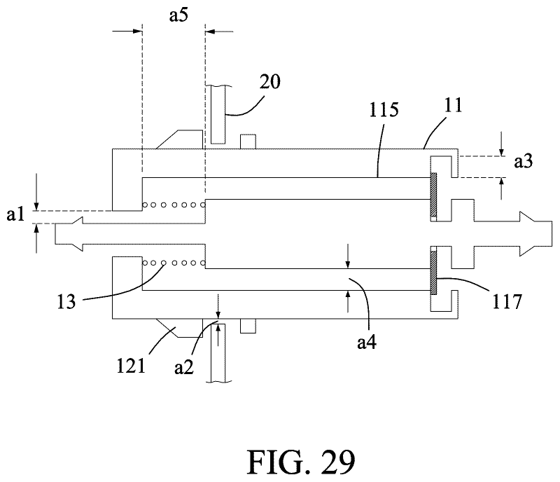

Referring to FIG. 29, as shown in the figure, in addition to the foregoing embodiments, in an embodiment of the present disclosure, a difference from the foregoing embodiments is that the body portion 11 is provided with a flow channel 115 therein, and an elastic element 13 and a limiting member 117 are arranged between the body portion 11 and the flow channel 115. The elastic element 13 and the limiting member 117 are configured to elastically limit the flow channel 115 to the body portion 11. In this way, the communicating structure 1 may be engaged with the object 20 through the body portion 11, and the flow channel 115 is used for guiding a fluid.

In addition to the foregoing embodiments, in an embodiment of the present disclosure, a difference from the foregoing embodiments is that a floating space a3 is provided between the body portion 11 and the limiting member 117, a floating space a4 is provided between the elastic element 13 and the body portion 11, and a floating space a5 is provided between the elastic element 13 and the flow channel 115. In this way, the body portion 11, the limiting member 117, and the flow channel 115 have a floating (or fine-tuning) function during operation through the floating spaces a3, a4, and a5 to meet the requirements of practical application and assembly.

In addition to the foregoing embodiments, in an embodiment of the present disclosure, a difference from the foregoing embodiments is that the flow channel 115 (or the body portion 11) may be a tube member, a pipeline, a quick connector, a liquid quick-release connector, a water-cooling liquid quick-release connector, a floating tube member, a floating connector, a metal member, a non-metallic member, a fastening member, an elastic member, a floating member, a blocking member, or a fluid channel. In this way, the present disclosure can better meet the requirements of practical application.

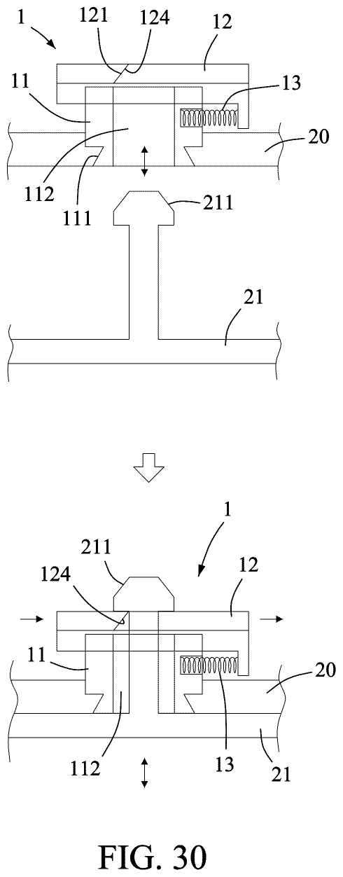

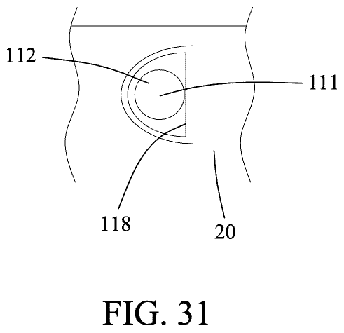

Referring to FIG. 30 and FIG. 31, as shown in the figures, in addition to the foregoing embodiments, in an embodiment of the present disclosure, a difference from the foregoing embodiments is that the joining portion 111 of the body portion 11 may be configured to be joined to the object 20, so that the another object 21 is engaged with the movable portion 12 through the joining portion 111 of the body portion 11, and the movable portion 12 and the another object 21 are easily assembled through an inclined surface 124 of the snap-fit portion 121 and a snap-fit inclined surface 211 of the another object 21. In this way, the body portion 11 may be snap-fitted to or unfastened from the another object 21 through the movable portion 12, to complete quick engagement and disengagement of at least two objects, thereby achieving the purpose of repeated and quick engagement and disengagement. In this way, the present disclosure can better meet the requirements of practical application.

In addition to the foregoing embodiments, in an embodiment of the present disclosure, a difference from the foregoing embodiments is that the joining portion 111 is provided with a rotation prevention portion 118, and the rotation prevention portion 118 may be configured to prevent rotation or limit a direction of the object 20. In this way, the present disclosure can better meet the requirements of practical application.

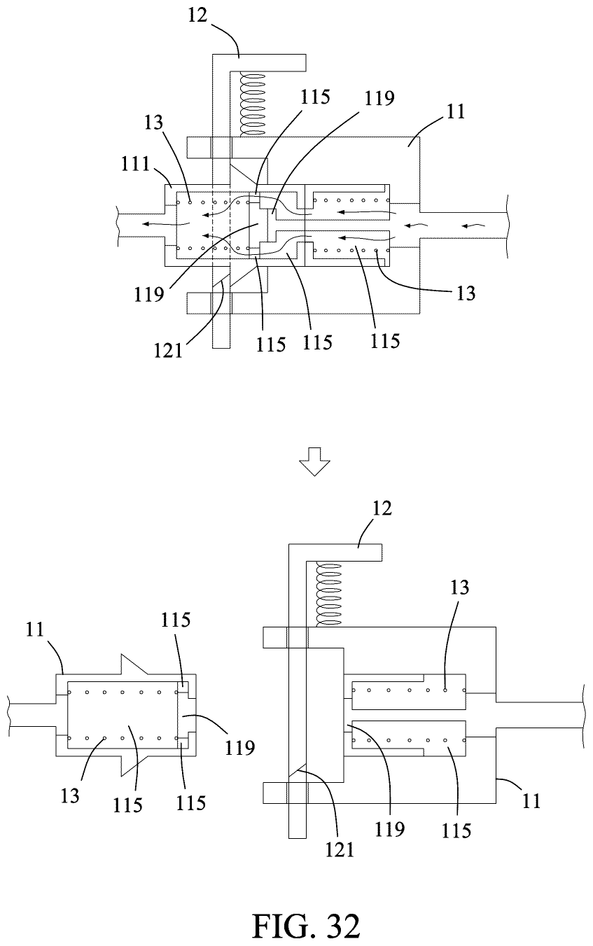

Referring to FIG. 32, as shown in the figure, in addition to the foregoing embodiments, in an embodiment of the present disclosure, a difference from the foregoing embodiments is that two body portions 11 are arranged. The body portions 11 each are provided with a blocking member 119. The blocking members 119 push against each other to open a flow channel 115 of each of the body portions 11, so that the fluid flows in the flow channel 115 in each of the body portions 11, or the two body portions 11 may be quick-release connectors or liquid quick-release connectors. In this way, the present disclosure can better meet the requirements of practical application.

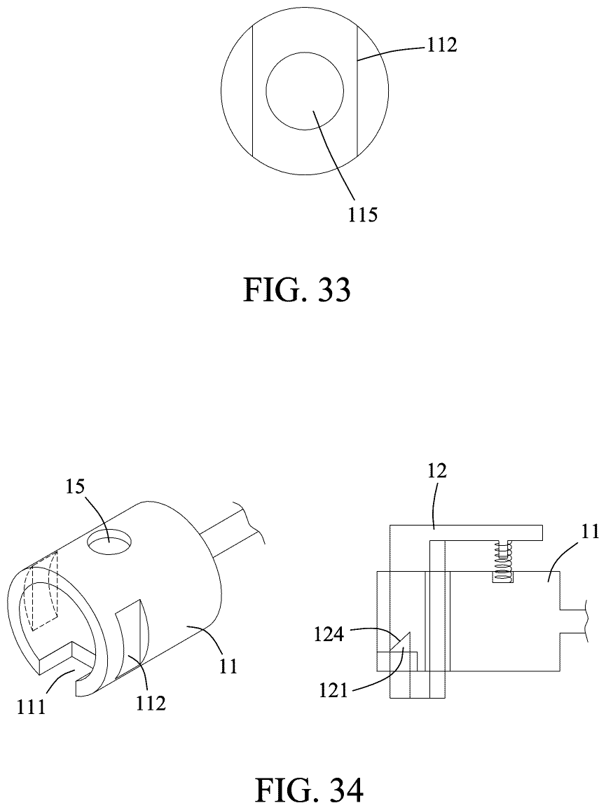

Referring to FIG. 33 and FIG. 34, as shown in the figures, in addition to the foregoing embodiments, in an embodiment of the present disclosure, a difference from the foregoing embodiments is that the body portion 11 is provided with a docking portion 112, and the docking portion 112 may be a rotation prevention structure to prevent rotation of the docking portion 112 and the movable portion 12. In this way, the present disclosure can better meet the requirements of practical application.

In addition to the foregoing embodiments, in an embodiment of the present disclosure, a difference from the foregoing embodiments is that the joining portion 111 may be a groove portion, a concave portion, a convex portion, a fastening portion, an open space, or an open structure, so that the joining portion 111 is configured to allow arrangement of the snap-fit portion 121 of the movable portion 12. In this way, the present disclosure can better meet the requirements of practical application.

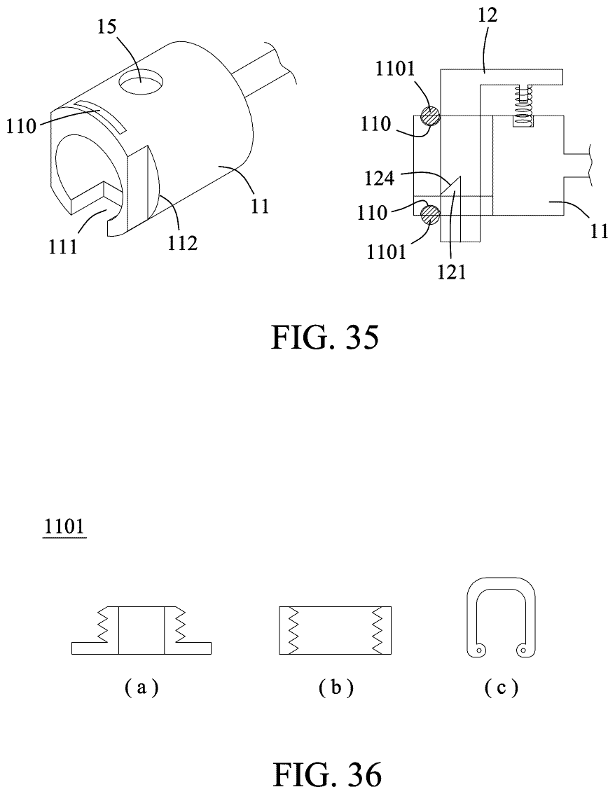

Referring to FIG. 35 and FIG. 36, as shown in the figures, in addition to the foregoing embodiments, in an embodiment of the present disclosure, a difference from the foregoing embodiments is that the body portion 11 is provided with an engaging portion 110. The body portion 11 is provided with the movable portion 12 and a fitting portion 1101 of the body portion is joined to the engaging portion 110 to limit the movable portion 12. In this way, the present disclosure can better meet the requirements of practical application.

In addition to the foregoing embodiments, in an embodiment of the present disclosure, a difference from the foregoing embodiments is that the fitting portion 1101 may be an externally threaded member (as shown in part a of FIG. 36), an internally threaded member (as shown in part b of FIG. 36), a snap member (as shown in part c of FIG. 36), a threaded member, a fastening member, a C-shaped buckle, a ring member, a riveted member, a welded member, or a flange riveted member. In this way, the present disclosure can better meet the requirements of practical application.

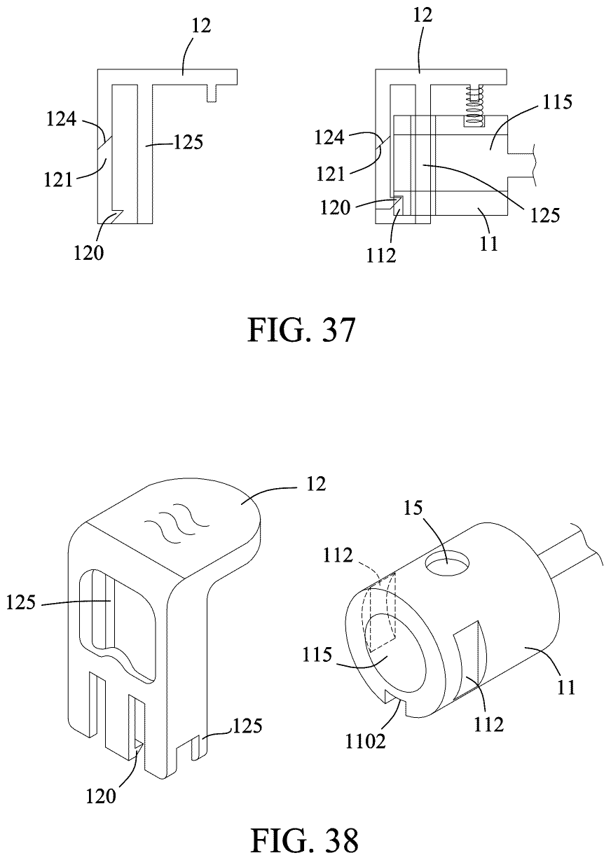

Referring to FIG. 37 and FIG. 38, as shown in the figures, in addition to the foregoing embodiments, in an embodiment of the present disclosure, a difference from the foregoing embodiments is that the body portion 11 is provided with a docking portion 112, and the movable portion 12 is provided with another docking portion 125. The movable portion 12 enters the body portion 11 through the another docking portion 125, so that the movable portion 12 is snap-fitted to a buckle portion 1102 of the body portion 11 through a snap portion 120. The buckle portion 1102 is an open structure, or the snap portion 120 passes over or through a flow channel 115 of the body portion 11 and then is snap-fitted to the buckle portion 1102. In this way, the present disclosure can better meet the requirements of practical application.

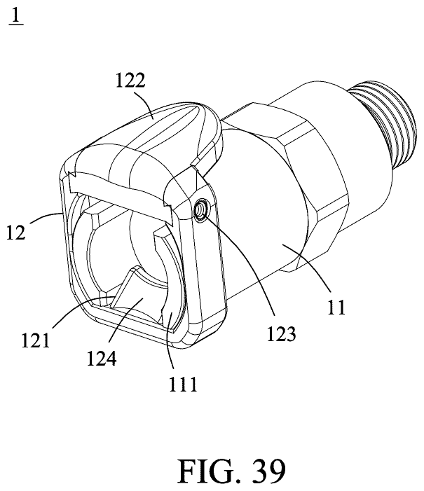

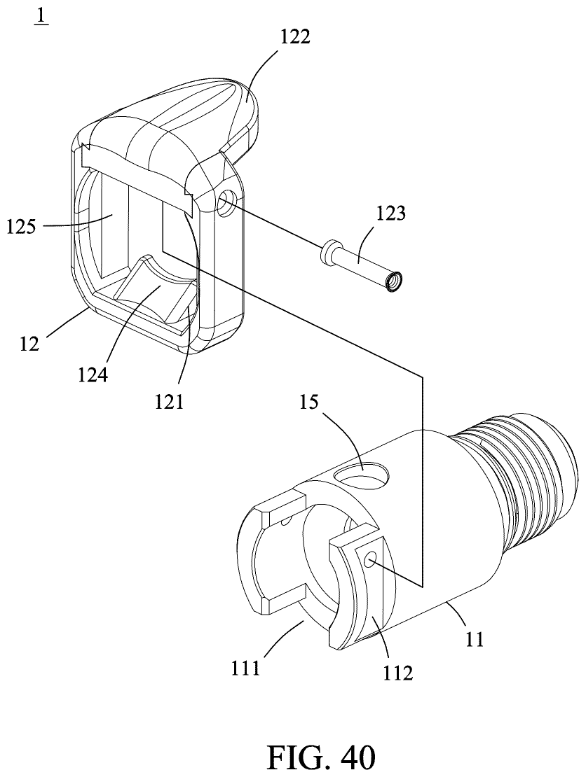

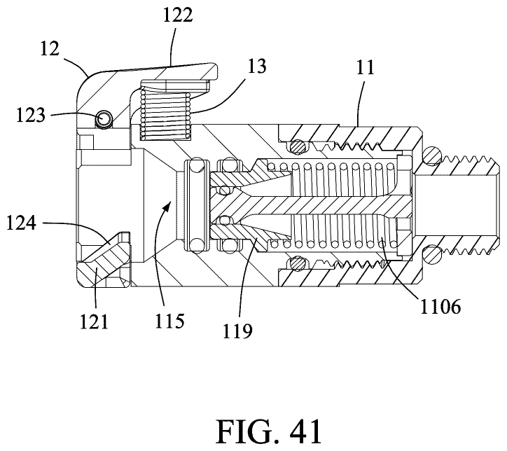

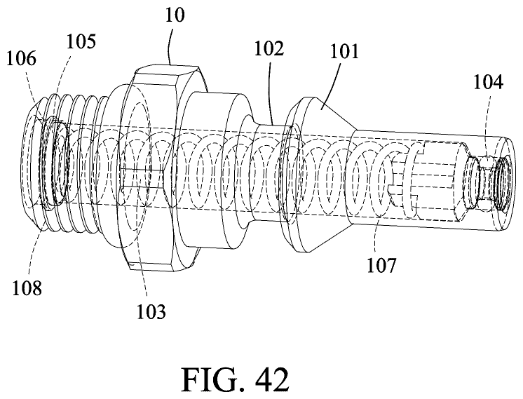

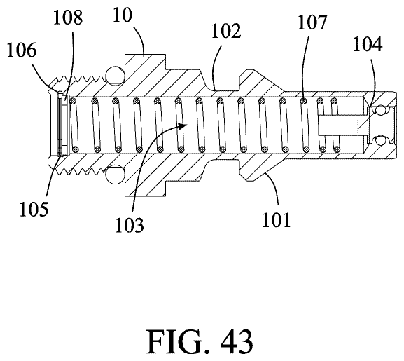

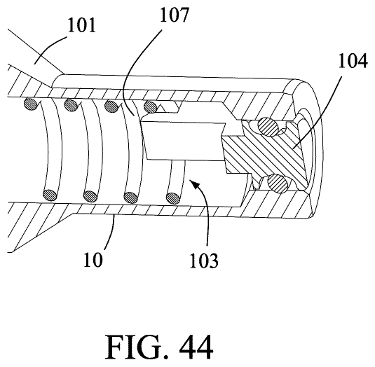

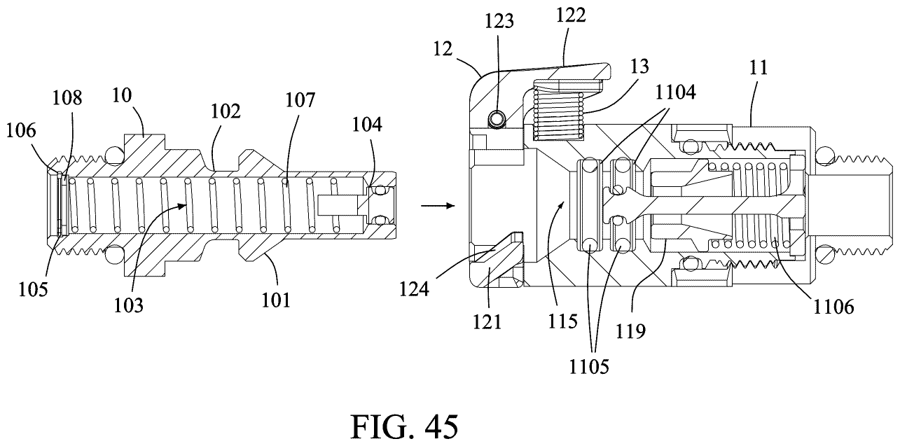

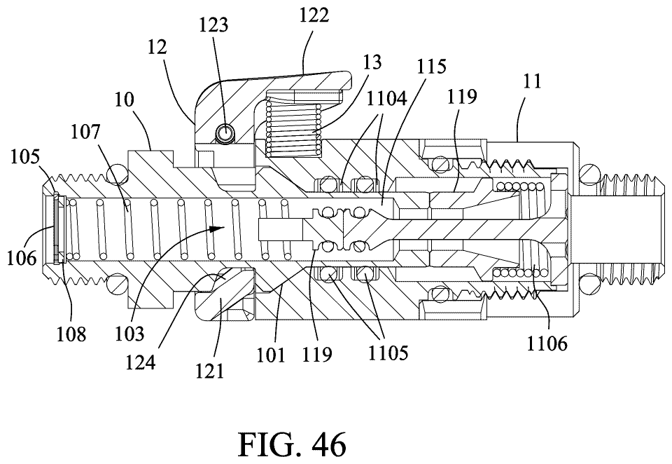

Referring to FIG. 39 to FIG. 46, as shown in the figures, in addition to the foregoing embodiments, in an embodiment of the present disclosure, a difference from the foregoing embodiments is that the body portion 11 and the another body portion 10 may each have a flow channel 115 and 103, the movable portion 12 is movably docked with the docking portion 112 of the body portion 11 through the another docking portion 125, and the movable portion 12 is movably fitted to the body portion 11 through a joining member 123. In the embodiments of the present disclosure, the movable portion 12 and the operating portion 122 are clamped and snap-fitted and then joined through the joining member 123, so that the body portion 11 is joined to the another body portion 10, and a receiving portion 102 of the another body portion 10 is snap-fitted (or unfastened) through the snap-fit portion 121. An inclined surface 124 of the snap-fit portion 121 is snap-fitted or moved corresponding to an inclined surface 101 of the another body portion 10, so that the body portion 11 pushes against blocking members 119 and 104 in the another body portion 10 to open the flow channels 115 and 103 of the water-cooling liquid, to complete quick engagement and disengagement of at least two objects, thereby achieving purpose of repeated and quick engagement and disengagement, and enabling the movable portion 12 and the another body portion 10 to be easily assembled. In addition, the blocking members 119 and 104 can respectively be a moving part.

In addition to the foregoing embodiments, in an embodiment of the present disclosure, a difference from the foregoing embodiments is that the another body portion 10 is provided with at least one mounting portion 105, a limiting member 106, an elastic member 107, and a blocking member 104. The mounting portion 105 is provided with the limiting member 106, so that the limiting member 106 limits elastic movement of the elastic member 107 and the blocking member 104. The limiting member 106 is provided with a blocking portion 108 to limit the elastic member 107 and the blocking member 104. The limiting member 106 and the blocking portion 108 respectively have channels 1061 and 1081, so that a structure of the limiting member 106 may allow the fluid passing through the body portion 11 and the another body portion 10 (the object 20) to pass through, allow the blocking member 119 in the body portion 11 to push against the blocking member 104 in the another body portion 10, and compress the another elastic element 1106 and the elastic member 107, thereby opening the flow channels 115 and 103 of the fluid, to enable the flow channels 115 and 103 to mate with the channels 1061 and 1081 to supply the required fluid. The fluid is water, a water-cooling liquid, oil, gas, or air, to complete the quick engagement and disengagement of at least two objects, thereby achieving the purpose of repeated and quick engagement and disengagement, and enabling the movable portion 12 and the another body portion 10 to be easily assembled.

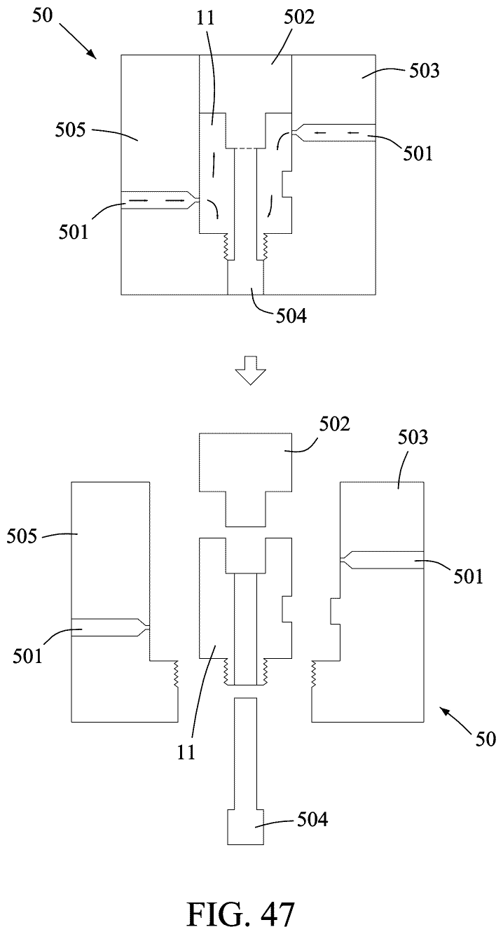

Referring to FIG. 47 to FIG. 50, as shown in the figures, in addition to the foregoing embodiments, in an embodiment of the present disclosure, a difference from the foregoing embodiments is that the body portion 11 or the another body portion 10 may respectively have flow channels 115 and 103, and the body portion 11 and the another body portion 10 are respectively formed through injection of a liquid material into a mold 50 and then curing (for example, formed through cooling and curing). The mold 50 has at least one flow path 501 for causing the liquid material to enter the mold 50 for forming the body portion 11 or the another body portion 10, and the mold 50 uses a combination of a plurality of modules 502, 503, 504, 505, 506, 507, 508, and 509 to form the body portion 11 and the another body portion 10. In the present disclosure, the mold 50 may be fitted through four different modules 502, 503, 504, and 505 to form the body portion 11, and the flow path 501 may be provided in the required modules 502, 503, 504, and 505. Other four different modules 506, 507, 508, and 509 are fitted to form the another body portion 10, and the flow path 501 may be provided in the required modules 506, 507, 508, and 509, so that the modules 502, 503, 504, 505, 506, 507, 508, and 509 block positions of the flow channels 115 and 103 to prevent the liquid material from flowing through the flow channels 115 and 103 to form the flow channels 115 and 103. The liquid material is a metal material, a non-metal material, or a plastic material. In this way, the liquid material may be injected into the flow path 501 of the mold 50 and cooled and cured into shape, and then the modules 502, 503, 504, 505, 506, 507, 508, and 509 may be demolded to form the body portion 11 and the another body portion 10.

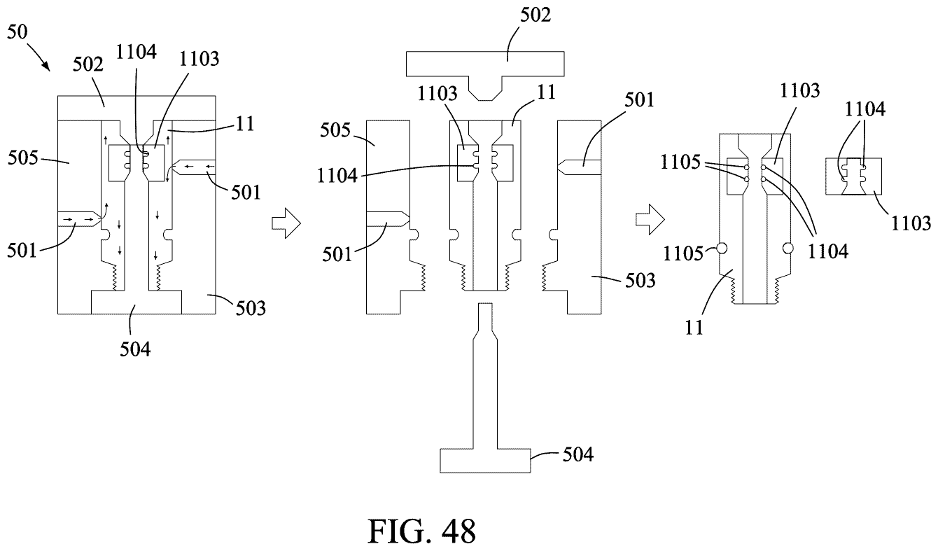

In addition to the foregoing embodiments, in an embodiment of the present disclosure, a difference from the foregoing embodiments is that the body portion 11 (or the another body portion 10) is provided with an embedded portion 1103. The embedded portion 1103 is configured to be placed in the mold 50 before liquid injection molding of the body portion 11 (or the another body portion 10), and a fluid blocking member 1105 is arranged on an arrangement portion 1104 of the embedded portion 1103. The embedded portion 1103 may be made of a metal material. The body portion 11 (or the another body portion 10) may be made of a plastic material. The fluid blocking member 1105 may be an O-ring, a rubber substance, a non-metallic substance, or a substance that may block a fluid. FIG. 47 shows a configuration in which the body portion 11 is not provided with the embedded portion 1103, and FIG. 48 shows a configuration in which the body portion 11 is provided with the embedded portion 1103. In addition, the embedded portion 1103 may also be put into the solid body portion 11 for assembly.

In addition to the foregoing embodiments, in an embodiment of the present disclosure, a difference from the foregoing embodiments is that two fluid blocking members 1105 are arranged. The embedded portion 1103 is configured to be placed in the mold 50 for liquid injection molding of the body portion and then a fluid blocking member 1105 is arranged on an arrangement portion 1104 of the embedded portion 1103, so that the another body portion 10 is docked with the body portion 11, and the fluid blocking member 1105 is configured to prevent a liquid flowing through the body portion 11 and the another body portion 10 from flowing out or overflowing.

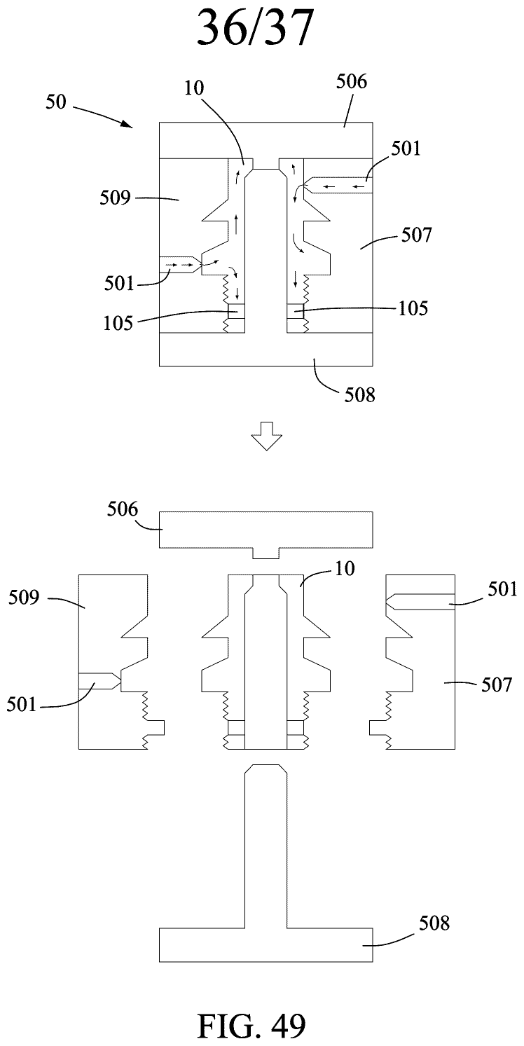

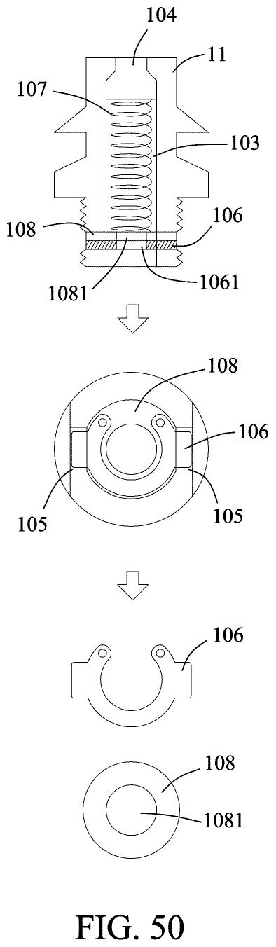

In addition to the foregoing embodiments, in an embodiment of the present disclosure, a difference from the foregoing embodiments is that the another body portion 10 (or the body portion 11) is stopped by the mold 50 to form the mounting portion 105 during liquid injection, so as to mount the limiting member 106 on the mounting portion 105 after formation. The limiting member 106 may be an elastic member configured to be snapped into the mounting portion 105, so that the limiting member 106 limits elastic movement of the elastic member 107 and the blocking member 104, and the blocking portion 108 is mounted on the limiting member 106 to limit the elastic member 107 and the blocking member 104. The mounting portion 105 may be a hole portion, a groove portion, a concave portion, or a convex portion (as shown in FIG. 49 and FIG. 50).

The present disclosure has been disclosed in the above with preferred embodiments. However, a person skilled in the art should understand that the embodiment is only used to illustrate the present disclosure, and should not be interpreted as a limitation on the scope of the present disclosure. It should be noted that all changes and substitutions equivalent to the embodiment should be considered to fall within the scope of the present disclosure. Therefore, the protection scope of the present disclosure is subject to the scope defined by the patent claims.

What is claimed is:

1. An communicating structure, comprising:
a body portion; and
a movable portion, configured to be movably fitted with the body portion, or configured to be snap-fitted to an object or another body portion.

2. The communicating structure according to claim 1, wherein the body portion is provided with at least one joining portion, the movable portion is movably fitted with the body portion, the movable portion is provided with at least one snap-fit portion fitted with the joining portion, and the snap-fit portion is snap-fitted to the object or the another body portion.

3. The communicating structure according to claim 1, wherein the body portion is provided with at least one joining portion, the movable portion is movably fitted with the body portion, the movable portion is provided with at least one snap-fit portion, or the snap-fit portion is configured to be snap-fitted to the object or the another body portion.

4. The communicating structure according to claim 1, wherein the movable portion is provided with an operating portion, the operating portion and the movable portion are joined through a joining member, the operating portion and the movable portion are first clamped or snap-fitted and then joined through the joining member, an elastic element is arranged between the movable portion and the body portion, or the elastic element is configured to provide an elastic force or an elastic force for movement and snap-fitting.

5. The communicating structure according to claim 1, wherein the body portion is provided with a docking portion, the docking portion has a metal portion with an electroplated surface docked with the movable portion, the docking portion is a cut edge, a cut groove, a groove portion, or a hole portion, the body portion or the movable portion is made of metal, non-metal, plastic, or metal subjected to heat treatment to increase elasticity; or the body portion is provided with a docking portion, the movable portion is provided with another docking portion, the docking portion and the another docking portion are docked with each other, or the docking portion or the another docking portion is a convex rib, a hole portion, or a groove portion.

6. The communicating structure according to claim 1, wherein the movable portion is a spherical member, a convex member, a concave member, a hook member, a fastening member, a snap member, or an elastic member, the movable portion is a snap-fit portion, the movable portion and the snap-fit portion are integrally formed or assembled, the snap-fit portion is a spherical member, a convex member, a concave member, a hook member, a snap member, or an elastic member, the body portion is provided with at least one joining portion, the movable portion is provided with at least one snap-fit portion fitted with the joining portion, the snap-fit portion is a hole portion or a groove portion, the joining portion is a hole portion or a groove portion, the joining portion or the snap-fit portion is manufactured into a hole portion or a groove portion through computer numerical control (CNC), lathing, or a milling machine, the joining portion is a riveted member, an expanded member, a locked member, a welded member, a welded member, a hole, a groove, a convex member, a concave member, or an object having a head portion, the joining portion or the snap-fit portion is formed through injection molding, in-mold injection molding, metal injection molding, or plastic injection molding, the snap-fit portion is a spherical member, a convex member, a concave member, a hook member, a snap member, or an elastic member, the body portion or the object or the another body portion is configured for a fluid to flow through, or the fluid is water, a water-cooling liquid, oil, a gas, or air.

7. The communicating structure according to claim 3, wherein one or two joining portions are arranged, and the joining portions are respectively docked with one or two snap-fit portions of the movable portion.

8. The communicating structure according to claim 3, wherein the snap-fit portion is provided with an inclined surface, the inclined surface is configured to be snap-fitted or move corresponding to an inclined surface of the another body portion or an inclined surface of another object, the snap-fit portion is a column member, a sheet member, or an inclined surface-equipped member, the movable portion is provided with an entry portion, the entry portion is configured for the another body portion to enter, the body portion is provided with a resisting portion configured to enable the object to be snap-fitted between the snap-fit portion and the resisting portion, a floating space is provided between the body portion and the object and is configured to float when the body portion is docked with the object, the snap-fit portion is provided with an actuating portion, the actuating portion is configured to actuate the snap-fit portion, the object is snap-fitted to or limited between the snap-fit portion and the actuating portion, the joining portion is joined to an object, the joining portion is provided with a rotation prevention portion, the rotation prevention portion is configured to prevent rotation or limit a direction of the object, or the joining portion is a groove portion, a concave portion, a convex portion, a fastening portion, an open space, or an open structure, so that the joining portion is configured to allow arrangement of a movable portion or a snap-fit portion of the movable portion.

9. The communicating structure according to claim 3, wherein the movable portion is provided with a movement space, another joining portion of the movable portion is fitted to the joining portion of the body portion through the movement space, the movable portion is fitted to or moves on the body portion, the movement space is joined to the another joining portion of the movable portion or is configured to be movably joined to the movable portion, the movable portion is provided with an elastic retraction space, the elastic retraction space is configured to allow the another joining portion of the movable portion to retract and then be snap-fitted to the joining portion, or the elastic retraction space is a groove, a hole, an open groove, or a closed groove.

10. The communicating structure according to claim 1, wherein the body portion is provided with a flow channel, a floating space is provided between the flow channel and the body portion and is configured for floating alignment for docking when the body portion is docked with the object, the body portion has a fluid quick-release connector or a flow channel joined thereto, the flow channel is in communication with a heat sink or a heating member to take away a heat source or reduce the heat source, the heat sink or the heating member is arranged in a server, a computer, an integrated circuit (IC), a chip, a conductor, a motherboard, a data center, or a storage, the communicating structure is a quick-release connector, or the communicating structure is a fluid quick-release connector.

11. The communicating structure according to claim 1, wherein a flow channel is provided in the body portion, an elastic element or a limiting member is arranged between the body portion and the flow channel, the elastic element and the limiting member are configured to elastically limit the flow channel in the body portion, a floating space is provided between the body portion and the limiting member, a floating space is provided between the elastic element and the body portion, a floating space is provided between the elastic element and the flow channel, the body portion or the flow channel is a tube member, a pipeline, a quick connector, a liquid quick-release connector, a water-cooling liquid quick-release connector, a floating tube member, a floating connector, a metal member, a non-metallic member, a fastening member, an elastic member, a floating member, a blocking member, or a fluid channel, two body portions are arranged, the body portions each are provided with a blocking member, the blocking members push against each other to respectively open a flow channel of each of the body portions, or to allow a fluid to flow in the flow channel in each of the body portions, or the two body portions are quick-release connectors or liquid quick-release connectors.

12. The communicating structure according to claim 11, wherein the blocking member is a moving part.

13. The communicating structure according to claim 1, wherein the body portion is provided with a docking portion, and the docking portion is a rotation prevention structure configured to prevent rotation of the docking portion and the movable portion; the body portion is provided with a docking portion, the movable portion is provided with another docking portion, the movable portion enters the body portion through the another docking portion, the movable portion is snap-fitted to a buckle portion of the body portion through a snap portion, the buckle portion is an open structure, the snap portion passes over or through a flow channel of the body portion and then is snap-fitted to the buckle portion; or the body portion is provided with an engaging portion, the body portion is provided with the movable portion and a fitting portion of the body portion is joined to the engaging portion to limit the movable portion, or the fitting portion is an externally threaded member, an internally threaded member, a snap member, a threaded member, a fastening member, a C-shaped buckle, a ring member, a riveted member, a welded member, or a flange riveted member.

14. The communicating structure according to claim 1, wherein the body portion or the another body portion has a flow channel, the body portion or the another body portion is formed through injection of a liquid material into a mold and then curing, the body portion or the another body portion is formed through injection of a liquid material into a mold and then cooling and curing, the body portion or the another body portion is formed through the mold using a combination of a plurality of modules, the mold or the modules block a position of the flow channel to prevent the liquid material from flowing through the flow channel to form the flow channel, the mold has at least one flow path for the liquid material to enter the mold to form the body portion or the another body portion, or the liquid material is a metal material, a non-metal material, or a plastic material.

15. The communicating structure according to claim 1, wherein the body portion or the another body portion is stopped by a mold to form a mounting portion during liquid injection, a limiting member is mounted to the mounting portion after formation, so that the limiting member limits elastic movement of an elastic member and a blocking member, a blocking portion is mounted to the limiting member to limit the elastic member and the blocking member, the limiting member is an elastic member configured to be snapped into the mounting portion, or the mounting portion is a hole portion, a groove portion, a concave portion, or a convex portion.

16. The communicating structure according to claim 15, wherein the blocking member is a moving part.

17. The communicating structure according to claim 1, wherein the body portion or the another body portion has a mounting portion, a limiting member is mounted to the mounting portion, so that the limiting member limits elastic movement of an elastic member and a blocking member, a blocking portion is mounted to the limiting member to limit the elastic member and the blocking member, the limiting member is an elastic member configured to be snapped into the mounting portion, the mounting portion is a hole portion, a groove portion, a concave portion, or a convex portion, or a structure of the limiting member allows passage of a fluid passing through the body portion or an object or the another body portion.

18. The communicating structure according to claim 17, wherein the blocking member is a moving part.

19. The communicating structure according to claim 1, wherein the body portion is provided with an embedded portion, the embedded portion is configured to be placed in a mold for liquid injection molding of the body portion, a fluid blocking member is arranged on an arrangement portion of the embedded portion; or the embedded portion is made of a metal material, the body portion is made of a plastic material; or the fluid blocking member is an O-ring, a rubber substance, a non-metallic substance, or a substance configured to block a fluid; or two fluid blocking members are arranged; or the embedded portion is configured to be placed in a mold for liquid injection molding of the body portion and then a fluid blocking member is arranged on an arrangement portion of the embedded portion; or the another body portion is docked with the body portion, the fluid blocking member is configured to prevent a liquid flowing through the body portion and the another body portion from flowing out or overflowing; or the body portion is provided with an embedded portion; or a fluid blocking member is arranged on an arrangement portion of the embedded portion; or the embedded portion is made of a metal material or a plastic material; or the body portion is made of a plastic material or a metal material; or the fluid blocking member is an O-ring, a rubber substance, a non-metallic substance, or a substance configured to block a fluid or two fluid blocking members are arranged; or the embedded portion is configured to be placed in a mold for liquid injection molding of the body portion and then a fluid blocking member is arranged on an arrangement portion of the embedded portion; or the embedded portion is configured to be placed in a solid body portion for assembly; or a fluid blocking member is arranged on an arrangement portion of the embedded portion, or the another body portion is docked with the body portion, and the fluid blocking member is configured to prevent the liquid flowing through the body portion and the another body portion from flowing out or overflowing.

20. The communicating structure according to claim 19, wherein the blocking member is a moving part.
